(19) United States
(12) Patent Application Publication
(10) Pub. No.: US 2011/0251331 A1
(43) Pub. Date: Oct. 13, 2011

(54) USE OF NANOTUBES, ESPECIALLY CARBON NANOTUBES, TO IMPROVE THE HIGH TEMPERATURE MECHANICAL PROPERTIES OF A POLYMERIC MATRIX

(76) Inventors: Thomas Page Mcandrew, Limerick, PA (US); Gilles Hochstetter, Bernay (FR); Michael Werth, Bernay (FR); Alain Bouilloux, Saubt-Leger De Rotes (FR); Benoit Brule, Beaumont-Le-Roger (FR); Patrickm. M. piccione, Pau (FR); Nour Eddine El Bounia, Orthez (FR); Christophe Roger, Limerick, PA (US); Emily Bressand, Aachen (DE)

(21) Appl. No.: 12/665,984

(22) PCT Filed: Jun. 25, 2008
(86) PCT No.: PCT/IB2008/053504

§ 371 Date: Dec. 22, 2009

Related U.S. Application Data
(60) Provisional application No. 60/946,517, filed on Jun. 27, 2007.

(51) Int. Cl. C08K 3/04; C08L 77/00; C08L 27/16; C08L 23/12; B82Y 30/00

(52) U.S. Cl. 524/495; 524/545; 524/583; 524/555; 977/742

(57) ABSTRACT

The present invention pertains to the use of nanotubes of at least one chemical element chosen from elements of groups IHa, IVa and Va of the periodic table to improve the high temperature mechanical properties of a polymeric matrix comprising at least one semi-crystalline thermoplastic polymer.

The present invention pertains to the use of nanotubes of at least one chemical element chosen from elements of groups IIIa, IVa and Va of the periodic table to improve the high temperature mechanical properties of a polymeric matrix comprising at least one semi-crystalline thermoplastic polymer.

It is known that some pipes, such as those used to carry hydrocarbons extracted from off-shore oil fields, are subjected to extreme conditions. Since these hydrocarbons are carried at a high temperature of about 130° C. and a high pressure of about 700 bars, acute problems of mechanical, thermal and chemical resistance of the materials are raised during the operation of the installations.

Some polymers such as PVDF (polyvinylidene fluoride) are known to provide a good thermal resistance and a good chemical resistance to solvents, as well as other beneficial properties such as gas and liquid impermeability. They have thus been used for manufacturing pipes intended to be used to carry hydrocarbons from off-shore or on-shore fields.

However, the high temperature life of these polymers is not always satisfactory, especially when they are subjected to stresses. The same drawback appears in the chemical industry for which it would be useful to provide appropriate pipes for carrying hot fluids such as sulphuric acid at about 120° C., 40% solutions of sodium hydroxide at about 70° C. or hot nitric acid.

Hence, there remains the need for a means for improving the resistance to high temperatures and more particularly the resistance to flow of a polymeric matrix.

It has now been discovered that this need could be satisfied by using nanotubes, such as carbon nanotubes, in said matrix.

The present invention thus pertains to the use of nanotubes of at least one chemical element chosen from elements of groups IIIa, IVa and Va of the periodic table to improve the high temperature mechanical properties of a polymeric matrix comprising at least one semi-crystalline thermoplastic polymer.

By “high temperature”, it is intended to designate a temperature between 75° C. and 250° C. and preferably between 100° C. and 200° C. The “mechanical properties” refer preferably to the resistance to flow and/or the modulus.

The resistance to flow can be measured according to the following method.

The test consists in imposing a constant tensile stress onto the test material and measuring the variation in the resulting strain as a function of time. For a given stress, the higher the resistance to flow, the lower the strain will be. Stress is independent of specimen geometry
represented as force per cross-section area. This specimen is usually an ISO 529-type tensile specimen. The strain is measured by means of a shift sensor (such as of the LVDT type) attached to the tensile specimen and the recording of the strain is made by acquisition onto a computer, at a typically logarithmic frequency so as to accommodate the slowing down of the process with time and not to saturate the acquisition system. The test machine may be a dynamometer such as those used for standard tensile tests, provided that it is possible to properly control the shift system of the moving cross-piece of the machine to which the specimen is attached, in order to be able to operate at a constant stress with time. This imposes a continuous and regular movement on the machine cross-piece so as to compensate for the elongation of the specimen with time. Another simpler system can be used, which involves charging the specimen with a dead load.

The nanotubes used in the present invention may be made from carbon, boron, phosphorus and/or nitrogen and for instance from carbon nitride, boron nitride, boron carbide, boron phosphide, phosphorus nitride and carbon nitride boride. Carbon nanotubes are preferred in the present invention.

They may be mono- or multiwall nanotubes. The multiwall nanotubes may be manufactured as described, for instance, by FLAHAUT et al. in Chem. Com. (2003), 1442. The multiwall nanotubes may be prepared as described, for instance, in WO 03/02456.

These nanotubes usually have a mean diameter from 0.1 to 200 nm, preferably from 0.1 to 100 nm, more preferably from 0.4 to 50 nm and, even better, from 1 to 30 nm. They may have a length between 0.1 and 10 μm and preferably around 6 μm. Their length to diameter ratio is advantageously more than 10 and usually more than 100. Their specific surface is for instance between 100 and 300 m²/g and their bulk density can range from 0.05 to 0.5 g/cm³ and preferably from 0.1 to 0.2 g/cm³. The multiwall nanotubes may for instance comprise from 5 to 15 walls and preferably from 7 to 10 walls.

An example of carbon nanotubes which may be used in this invention is available from ARKEMA under trade name Graphistrength® C100.

These nanotubes may be purified and/or oxidized and/or milled and/or functionalized before being used in the present invention.

The milling of these nanotubes may be carried out under cold or hot conditions and according to known processes carried out in devices such as ball mills, hammer mills, grinding mills, knife mills, gas jet mills or any other milling system apt to reduce the size of the entangled nanotubes. It is preferred that this milling step be conducted according to an air jet milling process.

The purification of the raw or milled nanotubes can be made by washing them by means of a sulphuric acid solution, so as to remove any mineral and/or metallic residual impurity which may come from their preparation process. The weight ratio of the nanotubes to the sulphuric acid can for instance range from 1:2 to 1:3. The purification step can be conducted at a temperature between 90 and 120° C., for instance during 5 to 10 hours. This step can be followed by rinsing and drying steps of the purified nanotubes, if needed.

The oxidation of the nanotubes is advantageously performed by bringing them into contact with a solution of sodium hypochlorite comprising from 0.5 to 15 wt % of NaOCl and preferably from 1 to 10 wt % of NaOCl for instance in a weight ratio of the nanotubes to the sodium hypochlorite of from 1:0.1 to 1:1. The oxidation is preferably conducted at a temperature of less than 60° C. and more preferably at ambient temperature, for some minutes to 24 hours. This oxidation step can be followed by filtration and/or centrifugation steps, a washing step and/or a drying step of the nanotubes, if needed.

The nanotubes can be functionalized by grafting reactive moieties such as vinyl monomers onto their surface. The material from which the nanotubes are made is then used as a free radical polymerisation initiator after a thermal treatment at more than 900° C. in an anhydrous and oxygen-free medium, the purpose of which is to remove oxygen groups from the nanotube surface. It is thus possible to polymerize methyl methacrylate or hydroxyethyl methacrylate onto the surface of the nanotubes in order to improve their dispersion in some matrices such as PVDF or polyamides, for instance.

The nanotubes used in the present invention are preferably raw nanotubes optionally milled but which have not been oxidized, purified, functionalized or chemically modified in any other way.

The polymeric matrix comprises a semi-crystalline thermoplastic polymer which may be, without limitation, chosen from:
polyamides such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10) and polyamide 6.12 (PA-6.12), some of which are marketed by ARKEMA under the trade name Rilsan® with the fluid grade polymers such as Rilsan® AMNO TLD being preferred, as well as copolymers, including block copolymers, comprising amide monomers and other monomers such as polytetramethylene glycol (PTMG))(Pebax°);
aromatic polyamides such as polyphthalamides;
fluoropolymers comprising at least 50 mol % and preferably consisting of monomers of formula (I):

CFX═CHX′ (I)

wherein X and X′ independently designate a hydrogen or halogen atom (especially fluorine or chlorine) or a perhalogenated alkyl radical (especially a perfluorated radical), such as (preferably α)polyvinylidene fluoride (PVDF), copolymers of vinylidene fluoride and for instance hexafluoropropylene (HFP), fluoroethylene/propylene copolymers (FEP), and copolymers of ethylene with any of fluoroethylene/propylene (FEP), tetrafluoroethylene (TFE), perfluoromethylvinyl ether (PMVE) or chlorotrifluoroethylene (CTFE), some of which are available from ARKEMA under the trade name Kynar® with the injection grade polymers such as Kynar® 710 or 720 being preferred;
polyolefins such as polyethylene and polypropylene;
thermoplastic polyurethanes (TPU);
polyesters such as polyethylene terephthalate (PET) or cyclic polybutylene terephthalate (CPBT);
silicon polymers; and
their mixtures.

The polymeric matrix can also contain at least one additive chosen from plasticizers, anti-oxygen stabilizers, light stabilizers, colouring agents, anti-impact agents, flame retardants, lubricants and their mixtures.

The nanotubes may represent from 0.5 to 30%, preferably from 0.5 to 10% and more preferably from 1 to 5% of the weight of the thermoplastic polymer.

The nanotubes and the polymeric matrix are preferably mixed by compounding by means of usual devices such as twin-screw extruders or kneaders. In such a process, granules of the polymeric matrix are typically mixed in the molten state with the nanotubes.

As an alternative, the nanotubes can be dispersed as a solution in a solvent into the matrix, by any appropriate means. In this case, the dispersion can be improved by means of specific dispersion devices or dispersing agents.

More specifically, the nanotubes may be dispersed into the polymeric matrix by sonication or by means of a rotor-stator device.

A rotor-stator device usually comprises a stator and a rotor controlled by an engine. The rotor is provided with a fluid guiding means disposed perpendicularly to the rotor axle. The rotor is optionally equipped with a toothed ring. The guiding means may comprise blades disposed substantially radially or a flat disk provided with peripheral teeth. The stator is disposed around said rotor at a small distance therefrom. The stator comprises, on at least a portion of its periphery, openings placed for instance in a grid or defined by a row of teeth between them. These openings are adapted for the passage of the fluid drawn into the rotor and ejected by the guiding means to these openings. One or more of said teeth may be provided with sharp edges. The fluid is thus subjected to a high shear, both between the rotor and the stator as well as inside the openings provided in the stator.

Such a rotor-stator device is available from SILVERSON under the trade name Silverson® L4RT. Another rotor-stator device is available from IKA-WERKE under the trade name Ultra-Turrax®. Other rotor-stator devices that can be mentioned are colloidal mills, for instance.

The dispersing agents may be chosen, among others, from plasticizers which may be selected from the group consisting of: phosphate alkylesters; hydroxybenzoic acid esters; lauric acid esters; azelaic acid esters; pelargonic acid esters; phthalates such as dialkyl or alkyl-aryl phthalates; dialkyl adipates; dialkyl sebacates (especially when the polymeric matrix contains a fluoropolymer); glycol or glycerol benzoates; dibenzyl ethers; chloroparaffins; propylene carbonate; sulfonamides and more specifically arylsulfonamides such as N-substituted or N,N-disubstituted benzylsulfonamides (especially when the polymeric matrix contains a polyamide); glycols; and their mixtures.

Usually, the amount of plasticizer will be limited to at most 6 wt % relative to the weight of the thermoplastic polymer.

As an alternative, the dispersing agent may be a copolymer comprising at least one anionic hydrophilic monomer and at least one monomer including at least one aromatic group, such as the copolymers described in FR-2 766 106, wherein the weight ratio of the dispersing agent to the nanotubes preferably ranges from 0.6:1 to 1.9:1.

In another embodiment, the dispersing agent may be homo- or copolymer of vinylpyrrolidone, wherein the weight ratio of the nanotubes to the dispersing agent preferably ranges from 0.1 to less than 2.

In a further embodiment, the dispersion of the nanotubes is improved by contacting them with at least one component A, which may be chosen among various monomers, polymers, plasticizers, emulsifiers, coupling agents and/or carboxylic acids, wherein both components are blended in the solid state or otherwise the mixture is provided in a powdered form after evaporation of any solvent used.

In still another preferred embodiment, the nanotubes may be introduced into the polymeric matrix, and thus used according to this invention, dispersed in a low-melting, low molecular weight resin, of which cyclic polybutylene terephthalate is a preferred example. The concentration of the nanotubes in said resin may be between 10 and 50%, with 25% being preferred.

The means described previously enable to improve the dispersion of the nanotubes in the polymeric matrix and may also enhance the conductivity, which may prove useful in some applications.

The nanotubes of the present invention may be used to reinforce polymeric matrices for manufacturing various items such as pipes or other hollow parts (such as pipe fittings) intended to hold or carry hot and possibly pressurized and/or corrosive fluids, for instance the impervious sheath of an off-shore flexible duct or of a pipe used in the chemical industry, and mono- or multilayer films.

The above items may be manufactured according to any appropriate process such as extrusion or injection.

When it is intended to be used for manufacturing off-shore flexible ducts, the thermoplastic polymer used in this invention is preferably chosen from: a vinylidene fluoride copolymer having a melting point of more than 140° C. and for instance of about 165° C., a polyvinylidene fluoride homopolymer having a viscosity higher than 12 kilopoises (kP) measured at 100 s⁻¹ and at 450° F. (232° C.) (ATSM D3835), preferably of an extrusion grade, which may be plasticized and impact reinforced by core-shells. This will allow to attain a compromise between a high mechanical strength under low temperature conditions (especially Charpy impact and multiaxial strain strength) and a high resistance to flow under high temperature conditions (such as 130° C.) and to blistering (typically 130° C. from 750 to 2500 bars, for instance for a decompression rate of 70 bar/min).

For applications under lower temperatures (at most 100° C.), a polyamide may be used as a thermoplastic polymer, such as PA-11, which may preferably be reinforced to improve its impact strength, so as to provide a good compromise between durability and resistance to flow under hot temperature conditions.

When it is intended to be used in the chemical industry, for instance to manufacture smooth pipes or injected pipe fittings, such as those carrying a corrosive fluid under pressure, the thermoplastic polymer of this invention may be a polyvinylidene fluoride homopolymer of the extrusion grade to make pipes or of the injection grade to make pipe fittings. The addition of nanotubes enables to significantly increase the use temperature of these items, the internal pressure of the fluid and/or the diameter of the pipes or pipe fittings.

This invention will be further explained with reference to the following examples, which are provided for the purpose of illustration only and should not be construed to limit the scope of this invention, taken in combination with the attached Drawings in which:

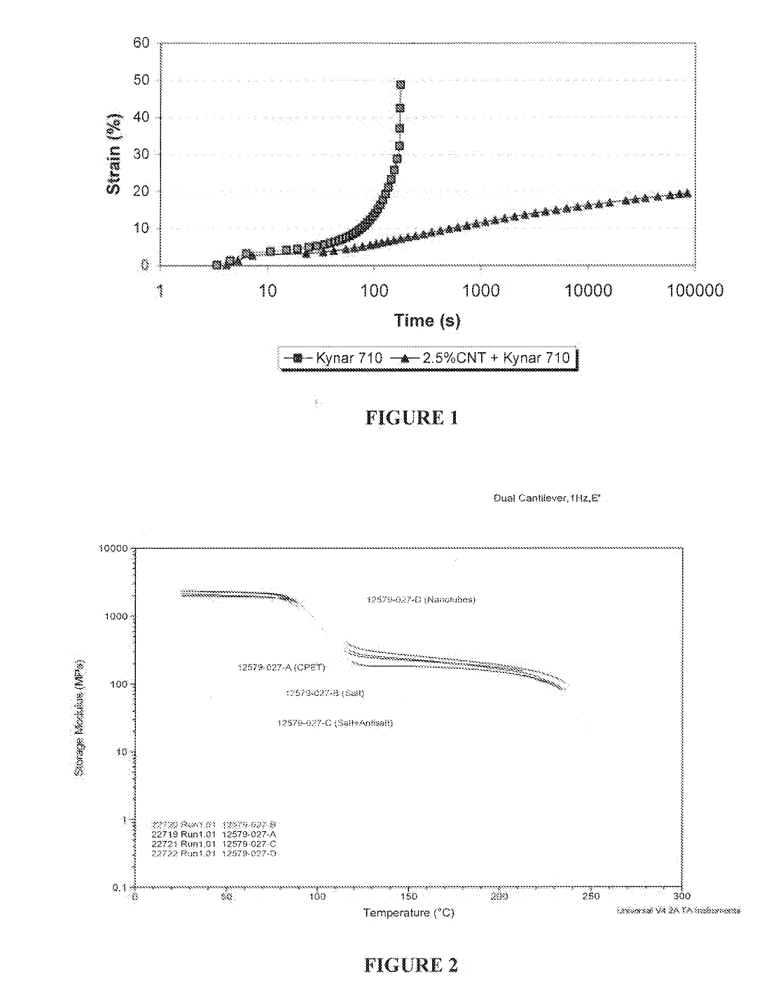

FIG. 1 shows the strain with time of two specimens made from PVDF, one of which only is reinforced with carbon nanotubes;

FIG. 2 shows the results of the DMA analysis performed on a composite that is 1% carbon nanotubes, 3% cyclic polybutylene terephthalate and 9% polyethylene terephthalate, as compared to a matrix that is 100% polyethylene terephthalate.

### EXAMPLES

### Example 1

Resistance to Flow of a PVDF Matrix Reinforced by Carbon Nanotubes

A PVDF homopolymer (Kynar K710 supplied by ARKEMA) in DMF (dimethylformamide) used as a solvent was mixed with 2.5 wt % of carbon nanotubes (Graphistrength® C100), based on the polymer weight. The mixing time was 8 min at 230° C. The speed rotation was 100 rpm.

The resistance to flow was measured at 130° C. under a stress of 9 MPa, according to the general test method described before and compared with the resistance to flow of the same polymer free from carbon nanotubes, under the same conditions. The resulting curve is illustrated in FIG. 1 which shows that the reinforced polymer deformed more slowly and much less than the polymer which did not include carbon nanotubes.

### Example 2

Resistance to Flow of a Polypropylene Matrix Reinforced by Carbon Nanotubes

A mixture of polypropylene Homopolymer (PPH) and 4 wt % carbon nanotubes (CNT) (Graphistrength® C100) was made on a static-mixer Rheocord Haake device. The mixing time was 7 min at 210° C. The speed rotation was 100 rpm.

The samples were compression molded at 210° C. and subjected to the following test.

The samples were analyzed on a dynamic mechanical analyser ARES® from Rheometrics at a frequency of 1 Hz. The geometry used was rectangular torsion for a temperature range of from −100 to 200° C. (measurement made every 2° C. with a temperature equilibrium time of 30 s). The initial strain imposed to the bar was 0.05% and was then automatically adjusted to provide a couple between 0.5 and 180 g.

The results are given in Table 1, wherein G′ refers to the modulus and Onset to the onset temperature, which is defined as the point corresponding to the change in the slope of G′ (melting of the crystalline phase).

TABLE 1

| | G′ (Pa) | | | |
|---|---|---|---|---|
| Reference | −100° C. | 25° C. | 100° C. | Onset (° C.) |
| PPH (control) | 2.20 × 10⁹ | 7.55 × 10⁸ | 1.90 × 10⁸ | 153.6 |
| PPH + 4% CNT | 3.04 × 10⁹ | 1.04 × 10⁹ | 3.33 × 10⁸ | 152.4 |

It follows from this table that the elastic modulus G′ was increased over the whole range of temperatures when PPH was added with carbon nanotubes. It increased by about 40% at the glass state and up to the glass transition temperature and by about 70% above 50° C. and up to the melting temperature. Moreover, it was determined that the glass transition temperature (Tg) and the melting temperature (Tm) remained unchanged.

### Example 3

Resistance to Flow of a PVDF Matrix Reinforced by Carbon Nanotubes

An experiment similar to Example 2 was conducted by incorporating 2 wt % of carbon nanotubes into a PVDF homopolymer 710. Various grades of carbon nanotubes were tested: raw (Graphistrength® C100).

The results are given in Table 2.

TABLE 2

| | G′ (Pa) | | | |
|---|---|---|---|---|
| Reference | −100° C. | 25° C. | 100° C. | Onset (° C.) |
| PVDF (control) | 2.90 × 10⁹ | 7.32 × 10⁸ | 2.30 × 10⁸ | 161.2 |
| PVDF + 2% raw CNT | 3.64 × 10⁹ | 9.00 × 10⁸ | 2.90 × 10⁸ | 161.3 |

It appears from this table that the addition of CNT to the polymeric matrix increased the modulus, although to a lesser extent than in Example 2 in view of the lower amount of CNT added.

### Example 4

Resistance to Flow of a Polyamide Matrix Reinforced by Carbon Nanotubes

A composite of carbon nanotubes (CNT) in cyclic polybutylene terephtalate (CBT) was made as follows: 21 g of CNT (Graphistrength® C100 supplied by ARKEMA) were added to 800 g of methylene chloride. Sonication was performed with a Sonics & Materials VC-505 unit set at 50% amplitude for ca. 4 hours. Stirring was continuous with a magnetic stir bar. To this was added 64 g CBT. Stirring on a roll mill was performed for ca. 3 days. The resultant mixture was cast on aluminum foil and solvent evaporated. Resultant powder is ca. 25% by weight CNT.

The composites thus obtained were added to polyamide-(PA-11) (Rilsan® BMNO PCG supplied by ARKEMA) in different amounts, by melt mixing on the DSM midi-extruder (15 cc capacity). Parameters were 210° C., 75 rpm, 10 min.

Thermal analysis (DSC) and oven melting experiments were conducted on these reinforced matrices and also on comparative matrices made from the same polymer either alone or mixed with CBT only. The various samples tested are given in Table 3 below.

TABLE 3

| Sample | Composition |
|---|---|
| 1 | PA-11 as received |
| 2 | PA-11—melt mixed 10 minutes at 210° C. |
| 3 | PA-11—melt mixed 10 minutes at 210° C. with |
| | CNT/CBT composite |
| 4 | PA-11—melt mixed 10 minutes at 210° C. with |
| | CNT/CBT composite |
| 5 | PA-11—melt mixed 10 minutes at 210° C. with CBT |
| | only |
| 6 | PA-11—melt mixed 10 minutes at 210° C. with CBT |
| | only |

The results are given in Table 4 below.

TABLE 4

| | | | | | ΔH (J/g) | | |
|---|---|---|---|---|---|---|---|
| | CNT | CBT | PA-11 | Tm | normalized to | Increase | |
| Sample | (%) | (%) | (%) | (° C.) | 100% PA-11 | (%) | Obs [symbol] |
| 1 | 0 | 0 | 100 | 190.6 | 56.9 | | [symbol] |
| 2 | 0 | 0 | 100 | 192.2 | 54.0 | | [symbol] |
| 3 | 2 | 6 | 92 | 190.5 | 68.4 | 27 | [symbol] |
| 4 | 5 | 15 | 80 | 189.1 | 75.6 | 40 | [symbol] |
| 5 | 0 | 6 | 94 | 194.4 | 49.4 | −8.5 | [symbol] |
| 6 | 0 | 15 | 85 | 189.8 | 66.0 | 22 | [symbol] |

[symbol]

indicates data missing or illegible when filed

From this table it appears that:
the presence of CNT increased the level of crystallinity in PA-11, which would lead directly to improved high temperature performance. Increase was beyond that observed in the corresponding blank experiment employing CBT only
in simple oven melting experiments, the presence of CNT resulted in an increased resistance to flow—even at 280° C.—well above the melting temperature of PA-11.

### Example 5

Resistance to Flow of a Polyester Matrix Reinforced by Carbon Nanotubes

The composites of CNT/CBT prepared as described in Example 4 were added to crystalline polyethylene terephthalate (CPET) (supplied by Associated Packaging Technologies) by melt mixing on a DSM midi-extruder (15 cc capacity), in respective amounts of 1% CNT, 3% CBT and 96% CPET. Prior to use, CPET was dried at ca. 110° C. for ca. 16 hours under partial vacuum (ca. 0.25 atm).

Extrudates were then dried at ca. 100° C. for 16 hours under partial vacuum (ca. 0.25 atm). Injection molding was subsequently performed by melting at 285° C. for 5-10 minutes, with injection into mold at 80° C. Injection molded pieces were dried at ca. 100° C. for 16 hours under partial vacuum (ca. 0.25 atm) prior to DMA analysis.

The results of the thermal analysis by DSC are shown in Table 5 below.

TABLE 5

| | 1^{st} Heat | | 1^{st} Cool | 2^{nd} Heat | | |
|---|---|---|---|---|---|---|
| | Tm | ΔH | Tc | Tm | ΔH | Increase |
| | (° C.) | (J/g) | (° C.) | (° C.) | (J/g) | (%) |
| Plain CPET | 258 | 43.3 | 215 | 253 | 48.1 | — |
| CPET + CNT/CBT | 258.1 | 44.3 | 223 | 255 | 52.2 | 8.5 |

From this table, it can be noted that the presence of CNT did not change the melting temperature (Tm) but slightly changed the crystallization temperature (Tc), which indicates that CNT served as nucleating agents. Above all, the presence of CNT raised the level of crystallinity, which will translate into an improved resistance to heat.

The results of the DMA analysis are shown on FIG. 2, from which it can be derived that the presence of 1% CNT (3% CBT) improved the storage modulus, giving better performance at higher temperature, compared to plain CPET.

In the claims:

1. A polymeric composition having good high temperature mechanical properties comprising nanotubes of at least one chemical element chosen from elements of groups IIIa, IVa and Va of the periodic table and a polymeric matrix comprising at least one semi-crystalline thermoplastic polymer.

2. The polymeric composition according to claim 1, characterized in that the mechanical properties are the resistance to flow and/or the modulus.

3. Use The polymeric composition according to claim 1, characterized in that the nanotubes are made from carbon, boron, phosphorus and/or nitrogen.

4. The polymeric composition according to claim 3, characterized in that the nanotubes are made from carbon nitride, boron nitride, boron carbide, boron phosphide, phosphorus nitride or carbon nitride boride.

5. The polymeric composition according to claim 1, characterized in that the nanotubes are carbon nanotubes.

6. The polymeric composition according to claim 1, characterized in that the nanotubes have a mean diameter between 0.1 and 150 nm.

7. The polymeric composition according to claim 1, characterized in that the nanotubes represent from 0.5 to 30 wt % of the thermoplastic polymer.

8. The polymeric composition according to claim 1, characterized in that the thermoplastic polymer is chosen from:
polyamides;
aromatic polyamides;
fluoropolymers comprising at least 50 mol % of monomers of formula (I):
CFX═CHX′ (I)
wherein X and X′ independently designate a hydrogen or halogen atom or a perhalogenated alkyl radical,
polyolefins;
thermoplastic polyurethanes (TPU);
polyesters;
silicon polymers; and
their mixtures.

9. The polymeric composition according to claim 1, characterized in that the polymeric matrix further includes at least one additive chosen from plasticizers, anti-oxygen stabilizers, light stabilizers, colouring agents, anti-impact agents, flame retardants, lubricants and their mixtures.

10. The polymeric composition according to claim 1, characterized in that the nanotubes are used as dispersed in a low-melting, low molecular weight resin.

11. The polymeric composition claim 7, characterized in that the nanotubes represent from 0.5 to 10 wt % of the thermoplastic polymer.

12. The polymeric composition claim 11, characterized in that the nanotubes represent from 1 to 5 wt % of the thermoplastic polymer.

13. The polymeric composition according to claim 8,
wherein said polyamides are selected from the group consisting of polyamide 6 (PA-6), polyamide 11 (PA-11), polyamide 12 (PA-12), polyamide 6.6 (PA-6.6), polyamide 4.6 (PA-4.6), polyamide 6.10 (PA-6.10) and polyamide 6.12 (PA-6.12), copolymers, block copolymers, and block copolymers comprising amide monomers and other monomers;
wherein said aromatic polyamides are polyphthalamides;
wherein in said fluoropolymers comprising at least 50 mol % of monomers of formula (I):
CFX═CHX′ (I)
wherein X and X′ independently designate a hydrogen or halogen atom
said halogen is fluorine or chlorine,
and said a perhalogenated alkyl radical is a perfluorated radical, selected from the group consisting of polyvinylidene fluoride (PVDF), copolymers of vinylidene fluoride and hexafluoropropylene (HFP), fluoroethylene/propylene copolymers (FEP), copolymers of ethylene with any of fluoro ethylene/propylene (FEP), tetrafluoroethylene (TFE), perfluoromethylvinyl ether (PMVE), and chlorotrifluoroethylene (CTFE);
wherein said polyolefins are polyethylene and/or polypropylene; and
wherein said polyesters are selected from the group consisting of polyethylene terephthalate (PET) and cyclic polybutylene terephthalate (CPBT).
